(19) United States
(12) Patent Application Publication
(10) Pub. No.: US 2014/0316823 A1
(43) Pub. Date: Oct. 23, 2014

(54) Systems and Methods To Promote Computerized Insurance Premium Quotes for losses suffered by Crowd Funding Website Subscribers

(71) Applicant: Luke Cooper, Baltimore, MD (US)

(72) Inventor: Luke Cooper, Baltimore, MD (US)

(21) Appl. No.: 14/170,559

(22) Filed: Jan. 31, 2014

Related U.S. Application Data
(60) Provisional application No. 61/759,353, filed on Jan. 31, 2013.

(51) Int. Cl. G06Q 40/08

(52) U.S. Cl. CPC G06Q 40/08
USPC 705/4

(57) ABSTRACT

A system and method for selling insurance products through crowdfunding websites is described. The system and method allow a provider to sell insurance products covering the risk of loss to a crowdfunding website subscriber, either directly or through a broker or aggregator, whereby a single GUI is used for the insurance and pledge or investment and the customer only has to enter their personal details once.

### CROSS-REFERENCE TO RELATED APPLICATIONS

This application claims benefit of priority of U.S. Provisional Application No. 61/759353, entitled “Computerized Insurance Premium Quote System for Investment Losses by Crowd Funding Website Investors and Retirement Savings Account Holders” filed Jan. 31, 2013, which is incorporated by reference in its entirety.

### FIELD OF THE TECHNOLOGY

The present technology relates to systems and methods for management of insurance products for subscribers to crowdfunding websites. More specifically, it relates to methods and systems for managing insurance to promote repayment of loans, donations, and investments in small businesses.

### DESCRIPTION OF THE RELATED ART

“Crowdfunding” describes a process of marketing an opportunity online directly to a large number of people, who each contribute a small amount of money towards the “crowdfunding campaign' s” goal. Crowdfunding is a relatively new field, and the first laws designed specifically to cover crowdfunding passed in 2012 (please see below). Cohen (U.S. Patent Publication No. 2014/0025473) applied for a patent covering crediting a funder's account with a sum of money when a third party performs an action, but this application describes a fundamentally different technology from that which is disclosed in the present invention. The present invention is designed to monitor the actions of crowdfunding fundraisers and pay the person who donated the funds in the event that the fundraiser defaults on specified conditions. This requires a much greater level of monitoring of the fundraiser's actions than the process described by Cohen. Furthermore, the present application claims priority to a provisional application that was filed before Cohen was published. In addition, the present invention includes a database of actuarial information, and a module which associates specific transactions with the prices of insurance within the database. These features are lacking in Cohen.

The Jumpstart Our Business Startups Act, popularly known as the “JOBS Act”, passed through Congress and, on Apr. 15, 2012, Title III enables “equity crowdfunding”, a new fundraising method. Crowdfunding occurs in several manners; Equity, which has become legal as a result of the JOBS Act; Debt, which is generally described as Peer to Peer Lending; and Rewards, which occurs when a small business provides a benefit or reward based on a donation solicited from the crowd. These innovations expand capital formation channels to both accredited investors and to the “ordinary American investor”. The struggle to strike the optimal balance between efficient capital formation and strong investor protection animates both Title II and Title III provisions as well as rule making by the Securities and Exchange Commission.

Accordingly, it may be desirable to implement methods and systems to promote insurance products so as to reduce the effects of non-performance and/or default situations.

### SUMMARY OF THE INVENTION

The present invention, as disclosed and described herein, comprises a computer-implemented method for providing insurance to individuals and business entities that lend, invest, or donate money through crowdfunding transactions. More particularly, the present invention provides a computer-implemented method for managing the purchase of insurance for losses arising from investments, loans, and pledges made on a crowdfunding portal through CF Transactions, comprising the steps of:
(a) receiving information from a subscriber about the subscriber's desire to purchase insurance related to a CF transaction, where the information is received via the internet or by other inter-computer communication;
(b) searching a database of actuarial information that is stored on a computer to determine the appropriate price for an insurance with a specified indemnification account value for a CF transaction of the type that the subscriber desires to ensure;
(c) sending information about the cost of the selected insurance policy to the subscriber via the internet or by other inter-computer communication;
(d) receiving payment from the subscriber;
(e) associating an indemnification account value with the CF Payment, the indemnification account value representing a monetary indemnification amount conditionally payable to the subscriber upon the occurrence of a repayment condition related to the CF Transaction;
(f) receiving any information from the subscriber that the subscriber chooses to send, via the internet or other inter-computer communication, about the occurrence of a repayment condition;
(g) monitoring default data representing whether or not fundraiser is in default on a payment related to the CF Transaction, the default data being associated with the indemnification account value;
(h) examining the default data with a digital processor upon receipt of information from the subscriber that a repayment condition has occurred; and
(i) releasing at least a portion of the indemnification account value to the subscriber as a function of the examination of the default data by the digital processor.

In another aspect, the present invention provides a computerized system for promoting repayment of crowdfunded transactions comprising:

a centralized computer which includes the following components:
a computer readable data storage medium containing a database of actuarial information related to CF transactions of various types
means for connecting to other computers via the internet or other methods
a computer readable data storage medium containing a database of subscribers who have bought insurance policies for different CF transactions, and the terms of these policies, and the CF transactions which were insured;

an indemnification account value, the indemnification account value associated with a transaction and representing an indemnification amount payable to a subscriber upon default of a condition concerning the transaction;

a database including default data representing whether or not the fundraiser is in default on a payment concerning the transaction, the default data being associated with the indemnification account value; and

a computer readable data storage medium containing processor control instructions for controlling processing of the default data with a digital processor and for controlling releasing of the indemnification account value as a function of the default data.

In yet another aspect, the present invention provides A machine readable medium having processor control instructions, said processor control instructions control a processor for managing the sale of insurance on a crowdfunding website, the processor control instructions comprising:

processor control instructions for associating an indemnification account value with a transaction, the indemnification account value representing a indemnification amount payable to a subscriber on the default of a payment condition relating to the transaction;

processor control instructions for monitoring default data representing whether or not the fundraiser is in default on an obligation relating to the transaction, the default data being associated with the indemnification account value; and

processor control instructions for examining the default data and for releasing the indemnification account value as a function of the examination of the default data.

### BRIEF DESCRIPTION OF THE DRAWINGS

The present technology is illustrated by way of example, and not by way of limitation, in the figures of the accompanying drawings, in which like reference numerals refer to similar elements.

FIG. 1 is a conceptual illustration of an embodiment of a system for managing insurance products for promoting performance and/or repayment of crowdfunding loans, rewards, or investments according to the present technology.

FIG. 2 is a flow chart for an example methodology for managing insurance indemnification accounts to protect subscribers from non-performance and/or default situations.

FIG. 3 illustrates components of an example apparatus for processing insurance for a subscriber account related data of the present technology.

FIG. 4 illustrates an example subscriber indemnification account data structure for a system of the present technology.

FIG. 5 illustrates components of a networked system for processing or managing subscriber indemnification accounts of the present technology.

FIG. 6 illustrates a computer-implemented method for providing insurance to individuals and business entities that lend, invest, or donate money through crowdfunding transactions.

### DETAILED DESCRIPTION

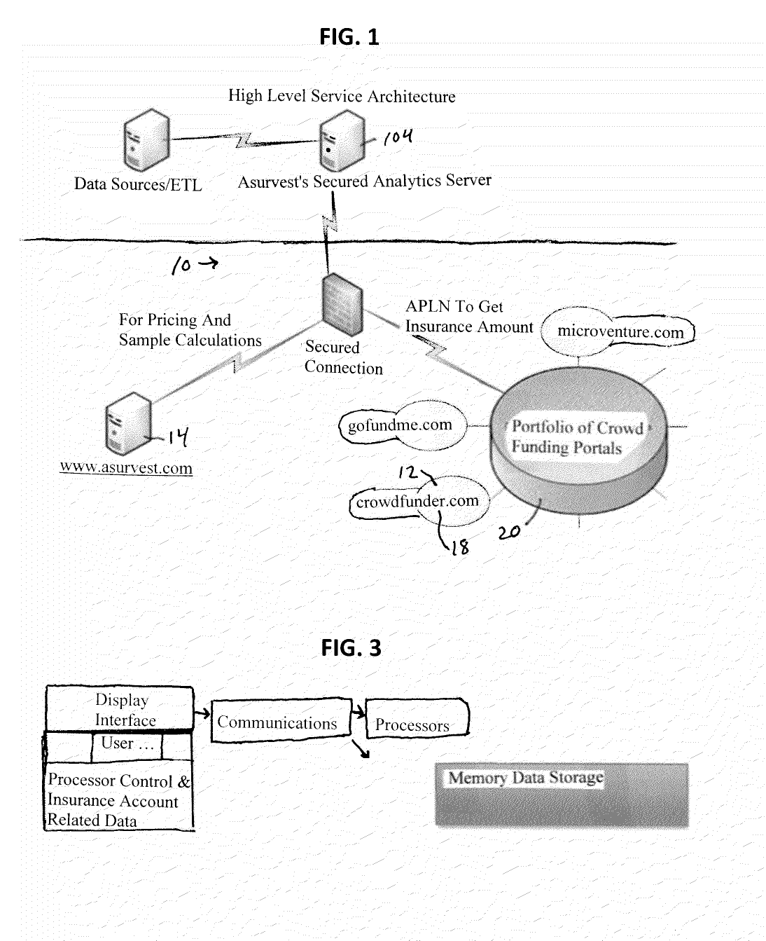

With reference to the drawings in which like parts have like reference numerals, FIG. 1 illustrates an example implementation of the present technology for managing generally 10 the purchase of insurance during a crowdfunding transaction through subscriber accounts. Typically, a crowdfunding website 12 will present information to the insurance provider 14 about the subscriber 16 and the fundraiser 18. The fundraiser 18, which may be an company or an individual raising funds on a crowdfunding portal 20, takes a payment 30 from a subscriber 16 and this accountholder may be an individual or a company as well. The transaction may obligate the fundraiser 18 to make periodic principal and/or interest payments during the term of a loan. In the case of equity investment or rewards based crowdfunding, it may require fulfillment or performance of conditions upon which the payment is made. In order to reduce the pain of a default, the subscriber 16 may opt 32 to select insurance coverage 28 until the conditions of the payment has been satisfied.

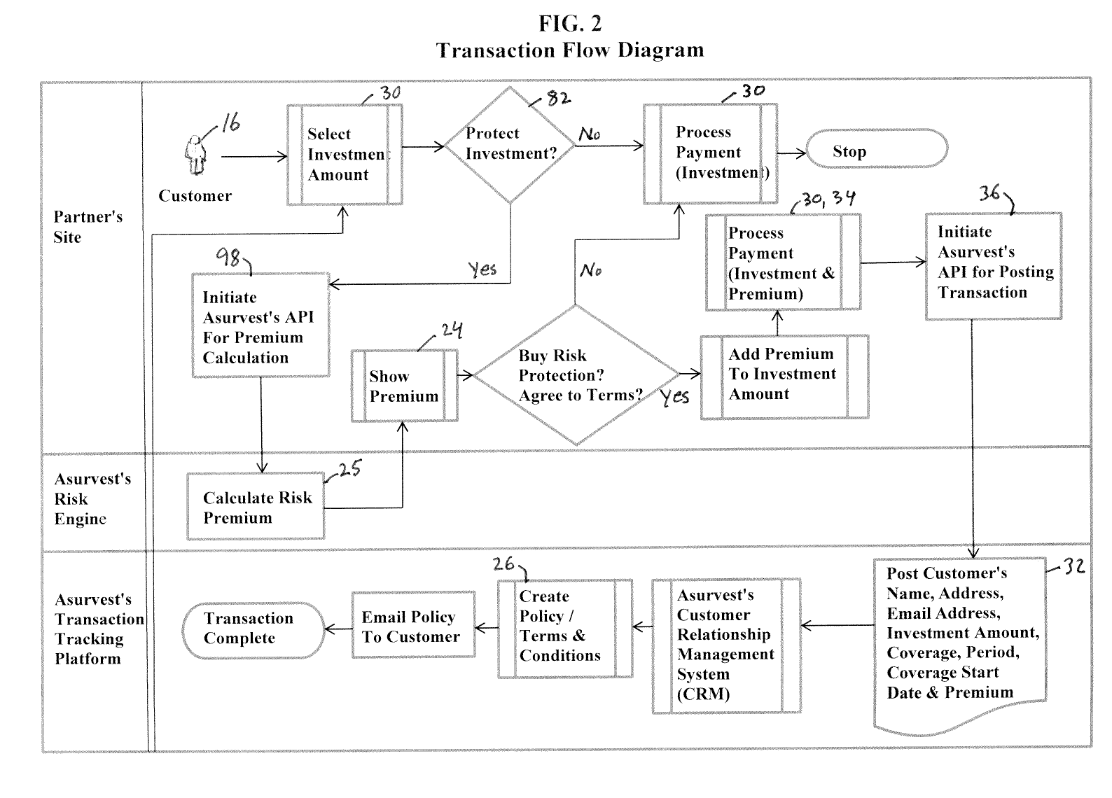

To provide additional incentive to the subscriber 16 to continue investing in small businesses on the crowdfunding websites 18, Asurvest may establish an insurance company 14. In the process of FIG. 2, a customer 22 is able to receive 24 a quotation for an insurance product 26 or purchase an insurance product directly from Asurvest or another insurance company or broker 14 without leaving the crowdfunding website 12. The crowdfunding website 12 will sell the provider's 14 insurance products 26 directly to the customer 22. The crowdfunding website 12 will act as an intermediary, and resell a provider's insurance products 26 to the subscriber 18.

In the process of FIG. 2, the subscriber's 16 information 32 is provided 23 to the insurance company 14 and the payment for the premiums 34 and the crowdfunding transaction 30 are collected on the crowdfunding website's payment system. Since the quotes are pre underwritten 25 subject to the subscriber 16 meeting any eligibility criteria required by the crowdfunding website 12, the insurance provider 14 is able to offer quotations and immediately sell the insurance product 26.

For the case of the provider 14 selling default risk insurance, the usual questions which may include investment amount, name and address of the fundraiser, nature of the fundraising activity (e.g., whether debt, equity, or reward based), subscriber personal information, subscriber accreditation status, and certification of anti-money laundering status of the subscriber may be discarded and replaced with eligibility criteria which state that the subscriber, for instance, must be an approved participant of the particular crowdfunding website.

In this manner, the crowdfunding portal 20 is able to provide quotations 24 and information for both the insurance products 26 as well as the crowdfunding transaction through the same graphical user interface, by inserting the eligibility criteria applicable to the requested insurance product into the GUI. In the same manner, so too can further information applicable to the insurance product 26 be inserted into the GUI. This further information may include the product brochure, important notices, policy variations and the standard policy wording. Thus the disadvantage of the customer being faced with a daunting array of GUIs when investing in a small business is overcome. In the described arrangement, the number of steps required to buy 34 the insurance product 26 while making the crowdfunding investment 30 remain consistent regardless of the insurance product type or investment. In this manner, a wide variety of crowdfunding investments may be accomplished.

In some embodiments, the default situation monitored may be based on determining whether or not the payments that are required/expressed by the original crowdfunding transaction are timely. Optionally, in FIG. 3 a subscriber indemnification account database 40 may be established to manage subscriber information and communications in the event of a default. In such embodiments, the database 40 would provide for rapid communication and status update of policies emanating from various crowdfunding transactions, whether occurring separate or in the aggregate. Thus, the management of the subscriber account and insurance payouts may be less burdensome to the insurance provider 14. Based on the status of these accounts, payments may then be automatically generated by the insurance provider and the account values adjusted accordingly.

Although FIG. 2 illustrates a single subscriber 16, single transaction and single indemnification account, it will be understood that the system 10 may be beneficially applied on a larger scale such that the insurance provider 14 manages indemnification accounts associated with many transactions and many subscribers 16. In such a system, an insurance provider 14 may implement computerized methods for managing and processing data for the indemnification accounts (e.g., term maturity data) and checking or monitoring the conditions related to the trigger events related to the indemnification accounts.

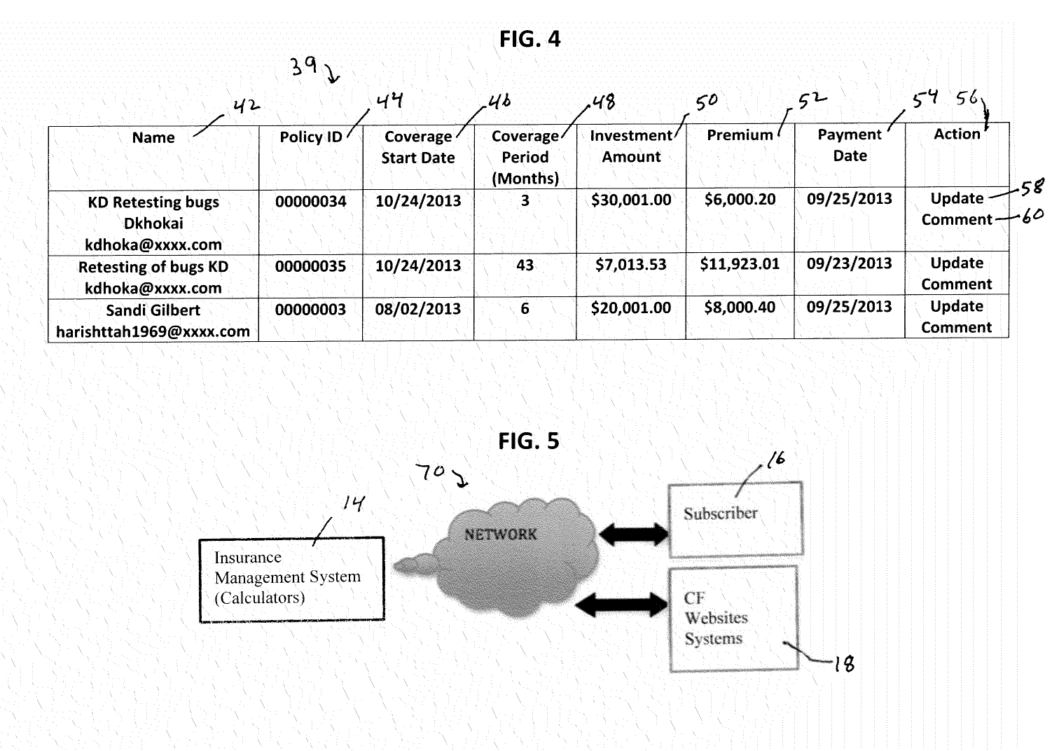

FIG. 4 represents the manner in which product information 39 from crowdfunding transaction as well as the insurance product 26 can be inserted into the single GUI offers cost saving advantages for the crowdfunding website 12. In the instance where the crowdfunding website 12 offers a new crowdfunding transaction to the market, the system 10 and methods of selling insurance products 26 do not need to be altered or developed and the subscriber 16 never has to leave the crowdfunding website 12 to complete its transaction and its simultaneous purchase of the insurance. The crowdfunding website 12 need only provide the necessary information pertaining to the transaction. This aspect of the invention provides a significant benefit, because of the generic computer structure and framework which applies to all insurance products and crowdfunding transactions (Refer to FIGS. 3 and 4), it is scalable with a minimum of new development work required to add new products.

As further illustrated in the embodiment of FIG. 4, the single GUI to provide insurance quotations and details of the crowdfunding transaction described above provides the advantage of a single point of entry for customer details. This may include simple selection of items displayed in the GUI, using drop down menus, or detecting the numeric data entry by the customer.

FIG. 4 illustrates the product information 39, including crowdfunding name 42, the policy id 44, the coverage date 46 and coverage period 48, the investment amount 50, the premium 52, the payment date 54, and action 56 including update 58 and comment 60.

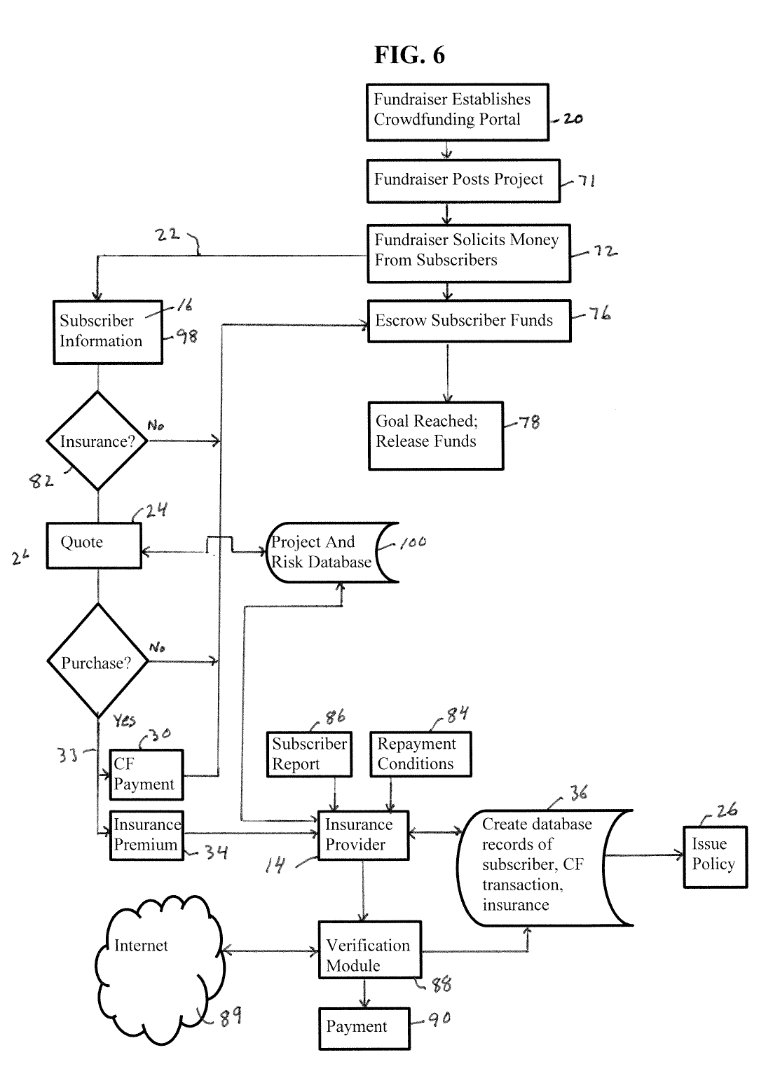

FIG. 5 shows suitable components of an example computerized system 10 for at least these processes in a system of the present technology. The automated methodologies may be implemented with hardware and/or software. For example, FIG. 5 shows components of an indemnification account established as part of a crowdfunding transaction. Such a transaction may occur using the cloud to monitor, process, display or otherwise manage the series of transactions in accordance with the embodiments described herein. The transaction may occur on dedicated servers or a computer or specific purpose computer with programmable processing control instructions.

With reference to FIG. 6, the present invention, as disclosed and described herein, comprises a computer-implemented method 70 for providing insurance 26 to individuals and business entities that lend, invest, or donate money through crowdfunding transactions. These individuals or businesses will be called “subscribers” 16 for the purposes of this application. “Crowdfunding” is a process by which a business or individual solicits 72 money via the internet 89 to fund a project 71. The individual or business soliciting the money will be called the “fundraiser” 18 for purposes of this application, for clarity. Crowdfunding generally takes place via websites, called “crowdfunding portals” 20, where crowdfunding generally involves the following: First, the fundraiser 18 posts 71 a description of the project on the “crowdfunding portal” 20. Crowdfunding portals 20 are websites which are designed to allow crowdfunding to occur easily. Crowdfunding portals 20 generally include the ability for subscribers 16 to lend, invest, or donate large or small amounts of money via the internet, for the combined donations of all subscribers to be held in escrow 76 by the crowdfunding portal 20 until the fundraiser's goal for the amount of money needed is reached, and then for the money to be released 78 to the fundraiser 18 when the fundraiser's goal for the amount of money raised is reached. A “crowdfunding transaction”, or “CF transaction” is when a subscriber 16 donates, lends or invests money to a fundraiser 18. A “crowdfunding payment” or “CF payment” 30 is the money that is given by the subscriber 16 as part of the crowdfunding transaction.

There is a certain risk that the fundraiser 18 will not perform whatever project the crowdfunding transaction was supposed to fund. This may arise from malfeasance on the part of the fundraiser 18 or simple business failure on the part of the fundraiser. It is a goal of the present invention to provide insurance 26 to allow the subscriber 16 to recoup the money that he paid as part of the CF payment if the fundraiser 18 fails to perform. In the present invention, if the fundraiser 18 meets one of several pre-programmed repayment conditions 92 which represent failure to perform, then the subscriber 16 receives the money that insurance policy 26 purchased 34 by the subscriber 16 was obligated to pay to the subscriber 16 upon occurrence of repayment condition. The subscriber 16 must report 86 the occurrence of the repayment condition in order to be paid. The invention contains a module 88 that “crawls” the internet 89 to verify the existence of repayment conditions. Examples of repayment conditions include the fundraiser 18 filing for bankruptcy, or, if the fundraiser is a corporation or other business entity, if the fundraiser files for dissolution. The invention may also be programmed to repay 84 the subscriber 16 if the fundraiser meets the repayment condition and continues to meet that condition after a grace period has elapsed. The invention may be programmed to automatically deposit 90 the monies due to the subscriber 16 in the subscriber's bank savings account. The subscriber 16 is also known as a “sponsor entity”.

The invention gives subscribers 16 the ability to protect their investments without having to do extensive due diligence. This can be critically important to the subscribers' ability to engage in CF transactions, because often, the amount of money that an individual subscriber 16 may give as part of a CF transaction may be small, perhaps as small as $20.

The invention includes an application module 98 through which subscribers 16 may fill in their information, information about the type of transaction they want to insure, and the amount of insurance that they want, online. The invention also includes a centralized database 100 stored on a centralized processor, where the database includes actuarial data about different kinds of investments, including information about the risk of occurrence of a repayment condition for different types of transactions. The invention also includes a module which determines what category of transaction the CF transaction that the subscriber has subscribed to belongs to. The invention includes a database 40 which includes the identities of the people who have bought insurance, and information about their policies. The invention includes the verification module 88 that “crawls” the internet 89 to verify the existence of a repayment condition.

In the foregoing description and in the accompanying drawings, specific terminology and drawing symbols are set forth to provide a thorough understanding of the present technology. In some instances, the terminology and symbols may imply specific details that are not required to practice the technology.

There is provided a system and method for selling insurance products on crowdfunding websites. The system and method allow a provider to sell insurance products to a subscriber, either directly or through a broker or aggregator, whereby a single graphical user interface (GUI) is used for all insurance products sold, and the customer only has to enter their personal details once when completing both the purchase of the insurance product as well as the crowdfunding transaction.

According to one aspect, there is pro sided a computer implemented method of selling an insurance product comprising the steps of receiving a first request comprising data pertaining to a crowdfunding transaction, processing the first request to determine data related to the crowdfunding transaction, outputting a response comprising the data related to the crowdfunding transaction to be inserted into the data fields of a graphical user interface, receiving a second request comprising data pertaining to an insurance product, processing the second request to determine data related to the insurance product and outputting a response comprising the data related to the insurance product to be inserted into the data fields of the graphical user interface.

According to a further aspect, there is provided a graphical user interface for facilitating at least a quotation to a customer of multiple crowdfunding insurance products comprising means for customer selection of plural insurance products, means for customer entry of limited risk criteria associated with each selected product, means for transmitting data associated with the selected products and limited criteria to a remote server, means for receiving from the remote server and simultaneously representing to the customer a quote for each selected product and means by which the customer can enter customer details and payment details to accept at least one of the quotes.

In some embodiments of the method, a digital processor is used to increase the remuneration account value as a function of increase data. The increase data may be an increase amount for the remuneration account value conditioned on a status of the delinquency data. The increasing may occur periodically during a term of the loan or mortgage loan. The method may also involve periodically crediting a financial account of the borrower as a function of a monetary amount during a term of the mortgage loan, the crediting being conditioned on a status of the delinquency data. Optionally, the remuneration account value may be a savings account and the method may also involve receiving an initial deposit for the savings account from a sponsor entity. Moreover, periodic deposits may be received for the savings account from a sponsor entity during a term of the mortgage loan as a condition of the delinquency data.

Moreover, although the technology herein has been described with reference to particular embodiments, it is to be understood that these embodiments are merely illustrative of the principles and applications of the technology. It is therefore to be understood that numerous modifications may be made to the illustrative embodiments and that other arrangements may be devised without departing from the spirit and scope of the technology. For example, while the technology may be applied to crowdfunding transactions, it may also be implemented with other types of web based consumer transactions.

In the context of this specification, the word “comprising” means “including principally but not necessarily solely” or “having” or “including,” and not “consisting only of.” Variations of the word “comprising,” such as “comprise” and “comprises” have correspondingly varied meanings. All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to he construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer-implemented method for managing the purchase of insurance for losses arising from investments, loans, and pledges made on a crowdfunding portal through CF Transactions, comprising the steps of:
(a) receiving information from a subscriber about the subscriber's desire to purchase insurance related to a CF transaction, where the information is received via the internet or by other inter-computer communication;
(b) searching a database of actuarial information that is stored on a computer to determine the appropriate price for an insurance with a specified indemnification account value for a CF transaction of the type that the subscriber desires to ensure;
(c) sending information about the cost of the selected insurance policy to the subscriber via the internet or by other inter-computer communication;
(d) receiving payment from the subscriber;
(e) associating an indemnification account value with the CF Payment, the indemnification account value representing a monetary indemnification amount conditionally payable to the subscriber upon the occurrence of a repayment condition related to the CF Transaction;
(f) receiving any information from the subscriber that the subscriber chooses to send, via the internet or other inter-computer communication, about the occurrence of a repayment condition;
(g) monitoring default data representing whether or not fundraiser is in default on a payment related to the CF Transaction, the default data being associated with the indemnification account value;
(h) examining the default data with a digital processor upon receipt of information from the subscriber that a repayment condition has occurred; and
(i) releasing at least a portion of the indemnification account value to the subscriber as a function of the examination of the default data by the digital processor.

2. The method of claim 1 wherein the step (i) comprises crediting at least a portion of the indemnification account value to a financial account of the subscriber when the default data monitored by the digital processor represents that one of the repayment conditions is in effect.

3. The method of claim 2 wherein the payment condition comprises full repayment of a principal and interest balance of a loan when the default data monitored by the digital processor represents that one of the repayment conditions is in effect.

4. The method of claim 2 wherein the crediting comprises a transfer of all of the indemnification account value to the borrower.

5. The method of claim 2 wherein the payment condition comprises non-completion of a particular principal or interest payment on a loan made on a crowdfunding portal.

6. The method of claim 1 wherein the step (i) releasing comprises cancelling the indemnification account value when the default data represents that the fundraiser has not been in default on a an obligation.

7. The method of claim 1 wherein the step (i) releasing comprises repayment of the indemnification account value when the default data represents that the fundraiser has been delinquent on an obligation and the subscriber has satisfied the payment condition during a grace period.

8. The method of claim 1 wherein the step (i) releasing comprises crediting at least a portion of the indemnification account value to a financial account of the subscriber when the delinquency data represents that the fundraiser has been delinquent on a payment to the subscriber and the subscriber has paid to maintain the insurance policy during a grace period.

9. The method of claim 1 further comprising the additional step of periodically crediting a financial account of the subscriber by a monetary amount during a term of the CF Transaction, the crediting being conditioned on a status of the repayment condition(s).

10. The method of claim 1 wherein the indemnification account value comprises a savings account and wherein the method further comprises receiving an initial deposit for the savings account from a subscriber.

11. The method of claim 10 further comprising receiving periodic deposits for the savings account from a sponsor entity during a term of the CF Transaction, when such deposits are made based on the status of the repayment condition(s).

12. A computerized system for promoting repayment of crowdfunded transactions comprising:
a centralized computer which includes the following components:
(i) a computer readable data storage medium containing a database of actuarial information related to CF transactions of various types
(ii) means for connecting to other computers via the internet or other methods
(iii) a computer readable data storage medium containing a database of subscribers who have bought insurance policies for different CF transactions, and the terms of these policies, and the CF transactions which were insured;
an indemnification account value, the indemnification account value associated with a transaction and representing an indemnification amount payable to a subscriber upon default of a condition concerning the transaction;
a database including default data representing whether or not the fundraiser is in default on a payment concerning the transaction, the default data being associated with the indemnification account value; and
a computer readable data storage medium containing processor control instructions for controlling processing of the default data with a digital processor and for controlling releasing of the indemnification account value as a function of the default data.

13. The computerized system of claim 12 wherein the releasing comprises crediting at least a portion of the indemnification account value to a financial account of the subscriber when the delinquency data represents that the fundraiser has defaulted on an obligation related to the transaction and the subscriber has satisfied the payment condition.

14. The computerized system of claim 12 wherein the payment condition comprises non-payment of a principal and interest balance related to the transaction and the crediting comprises a transfer of all of the indemnification account value to the subscriber.

15. The computerized system of claim 12 wherein the payment condition comprises non-delivery of a product related to the transaction and the crediting comprises a transfer of all of the indemnification account value to the subscriber.

16. The computerized system of claim 12 wherein the payment condition comprises non-delivery of a service related to the transaction and the crediting comprises a transfer of all of the indemnification account value to the subscriber.

17. The computerized system of claim 12 further comprising a digital processor having a memory with processor control instructions, said processor control instructions controlling the processor to decrease the indemnification account value as a function of increase data, the increase data comprising an increase amount for the indemnification account value conditioned on a status of the default data.

18. The computerized system of claim 12 wherein the increasing occurs periodically during a term of the crowdfunding transaction.

19. A machine readable medium having processor control instructions, said processor control instructions control a processor for managing the sale of insurance on a crowdfunding website, the processor control instructions comprising:
processor control instructions for associating an indemnification account value with a transaction, the indemnification account value representing a indemnification amount payable to a subscriber on the default of a payment condition relating to the transaction;
processor control instructions for monitoring default data representing whether or not the fundraiser is in default on an obligation relating to the transaction, the default data being associated with the indemnification account value; and
processor control instructions for examining the default data and for releasing the indemnification account value as a function of the examination of the default data.

20. The machine readable medium of claim 19 wherein the releasing comprises crediting at least a portion of the indemnification account value to a financial account of the subscriber when the default data represents that the fundraiser has been delinquent on an obligation related to the transaction and the subscriber has satisfied the payment condition.

21. The machine readable medium of claim 19 wherein the payment condition comprises non-payment of a principal and interest balance of a loan and the crediting comprises a transfer of all of the indemnification account value to the subscriber.

22. The machine readable medium of claim 19 wherein the payment condition comprises non-delivery of a product and the crediting comprises a transfer of all of the indemnification account value to the subscriber.

23. The machine readable medium of claim 19 wherein the payment condition comprises non-delivery of an interest balance of a loan and the crediting comprises a transfer of all of the indemnification account value to the subscriber.

24. The machine readable medium of claim 19 wherein the releasing comprises crediting at least a portion of the indemnification account value to a financial account of the subscriber when the default data represents that the fundraiser has defaulted on an obligation related to the transaction and the fundraiser has not cured the default during a grace period.

25. The machine readable medium of claim 19 wherein the increasing occurs periodically during discrete terms of the transaction.

26. The machine readable medium of claim 19 further comprising periodically crediting a financial account of the subscriber by adding a monetary amount to the account during a term of the agreement, the crediting being conditioned on a status of the delinquency data.

27. The machine readable medium of claim 19 wherein the indemnification account value comprises a savings account and wherein the method further comprises receiving an initial deposit for the savings account from a sponsor entity.
